(19) United States
(12) Patent Application Publication
(10) Pub. No.: US 2006/0168126 A1
(43) Pub. Date: Jul. 27, 2006

(54) Aggregated content listing for ad-hoc peer to peer networks

(76) Inventors: Jose Costa-Requena, Helsinki (FI); Tao Wu, North Andover, MA (US)

Correspondence Address: Hollingsworth & Funk, LLC;Suite 125, 8009 34th Avenue South, Minneapolis, MN, 55425, US

(21) Appl. No.: 11/019,934

(22) Filed: Dec. 21, 2004

(51) Int. Cl. G06F 15/16

(52) U.S. Cl. 709/219

(57) ABSTRACT

Providing access to content in an ad-hoc peer-to-peer network involves gathering, from a plurality of media servers coupled to the network, content listings that describe content available via the associated media server. A subset of the content listings is selected based on an identity associated with a control point device. An aggregated content listing is presented to the control point device based on the selected subset of the content listings.

### FIELD OF THE INVENTION

This invention relates in general to computer networking, and more particularly to a system, apparatus and method for providing content listings in peer-to-peer networks.

### BACKGROUND OF THE INVENTION

The nature of mobile communications infrastructures often means that mobile devices such as cellular phones are tied to particular service provider networks. Although there has been some standardization in the industry, the choice of a provider is still the primary consideration when choosing a mobile device. However, there is increasing demand for mobile devices that connect to more than a single provider network.

The ubiquity of cellular phones has led to demands for more general purpose computing features in these devices. For example, programs such as personal information managers and email clients are particularly useful when combined with the always-at-ready, always-connected nature of cell phones. This has led to demand for phones that can connect to a variety of networks. For example, mobile devices may include features that allow interaction with other consumer electronics devices.

A standard known as Universal Plug and Play™ (UPnP) provides a way for disparate processing devices, including mobile devices, to exchange data over local networks. The UPnP standard defines an architecture for peer-to-peer network connectivity utilizing a wide variety of electronic devices. The UPnP standard includes standards for service discovery, and is mainly targeted for proximity or ad hoc networks.

Various contributors publish UPnP device and service descriptions, thus creating a way to easily connect devices and simplifying the implementation of networks. UPnP is designed to work in many environments, including the home, businesses, public spaces, and on devices attached to the Internet. The UPnP standard is an open architecture that leverages Web technologies and is designed to provide ad-hoc networking and distributed computing.

The UPnP model is designed to support zero-configuration networking and automatic discovery for a wide variety of device categories. This allows a device to dynamically join a network, obtain an Internet Protocol (IP) address, convey its capabilities, and learn about the presence and capabilities of other devices. Many local network and Internet-based protocols such as Dynamic Host Configuration Protocol (DHCP) and Domain Name Service (DNS) may be included in a UPnP network. A device can leave a UPnP network smoothly and automatically without leaving any unwanted state behind.

The UPnP architecture includes mechanisms for discovery of devices on the network and mechanisms for describing capabilities of those devices. The UPnP discovery protocol allows a device to advertise its services to network entities by utilizing multicast messages. Multicasting refers to a sending a single copy of data to multiple recipients on an IP network. Devices can multicast one or more service announcement messages. Each message describes an embedded device and/or service available from the message's originator. Other devices on the network listen on the multicast address for these service announcement messages. The devices use this information to discover and utilize UPnP services.

Devices on a UPnP network may take on a number of roles. For example, UPnP devices can act as control points, renderers, and media servers. A media server generally makes data available for use by other UPnP entities. For example, a UPnP renderer can take data from a media server and present the data in a perceivable form. A device acting as UPnP control point allows the user to see and control disposition of data between UPnP entities such as renderers and media servers.

UPnP also defines a Content Directory Service (CDS), which allows media servers and similar devices to expose available content in an XML tree data structure. The content discoverable via the CDS may include individual pieces of content such as songs and video clips. The CDS content may also include containers, which represent collections of items such as playlists and photo albums. Each CDS content object, whether an item or container, includes metadata that describes various attributes of the object, such as title, artist, etc.

A mobile device such as a cellular phone may be adapted as both a UPnP rendering device and as a UPnP control point. In order to act as a control point on a UPnP network, the cell phone may access the CDS available on one or more media servers. However, it will be appreciated that home media servers may each contain a large number of entries. Even a reasonably fast computer can take an appreciable amount of time retrieving and indexing a large number of CDS entries on various server devices. When a large number of entries are accessed using a small, low-bandwidth device such as a cell phone, the time lag in retrieving the CDS data may be unacceptable. Therefore there is a need for an efficient and user-friendly way to search and locate content in these types of local network environments.

### SUMMARY OF THE INVENTION

To overcome limitations in the prior art described above, and to overcome other limitations that will become apparent upon reading and understanding the present specification, the present invention discloses a system, apparatus and method for providing access to content in an ad-hoc peer-to-peer network.

In accordance with one embodiment of the invention, a method for providing access to content in an ad-hoc peer-to-peer network involves gathering, from a plurality of media servers coupled to the network, content listings that describe content available via the associated media server. A subset of the content listings is selected based on an identity associated with a control point device. An aggregated content listing is presented to the control point device based on the selected subset of the content listings.

In more particular embodiments, the method may involve placing all of the content listings and/or a selected subset of the content listings gathered from the media servers into the aggregated content listing. The method may also involve modifying at least a portion of the aggregated content listing so that the subset of content listings is in a consistent format. Modifying the aggregated content may involve removing and or adding elements from the content listings. Added elements may be stored in a database separate from the content listings of the media servers. The portion of the aggregated content listing may be modified based on the identity associated with the control point device.

In one configuration of the method, selecting the subset of the content listings involves selecting the subset based on a user identity associated with the control point device. The subset may also be selected based on a bandwidth capability associated with a rendering function of the control point device. The method may further involve storing, with the content listing, a profile associated with the user identity. The profile is used to select the subset of content listings. The ad-hoc peer-to-peer network may include a Universal Plug and Play network.

In another embodiment of the present invention, an apparatus includes a network interface capable of communicating via an ad-hoc peer-to-peer network. A processor is coupled to the network interface and a memory is coupled to the processor. The memory includes a content gathering module having instructions that cause the processor to gather, from a plurality of media servers coupled to the network, content listings that describe content available via the associated media server. The memory also includes a directory service module having instructions that cause the processor to: accept, via the network interface, requests for content listings from one or more control point devices coupled to the network; select a subset of the content listings based on an identity associated with the control point devices; and present, to the control point devices via the network interface, an aggregated content listing based on the selected subset of the content listings.

In more particular embodiments, the apparatus may include a transformation module having instructions that cause the processor to modify at least a portion of the aggregated content listing. The apparatus may also include a preferences module having instructions that cause the processor to store a profile associated with the user identity. The directory service module uses the profile to select the subset of content listings.

In another embodiment of the present invention, an apparatus includes a network interface capable of communicating via an ad-hoc peer-to-peer network. A processor is coupled to the network interface and a memory is coupled to the processor. The memory includes instructions that cause the processor to: select an identifier usable for accessing an aggregated content directory service; submit the identifier to the aggregated content directory service, the aggregated content listing containing entries gathered from a plurality of media servers accessible via the network interface; and request an aggregated content listing from aggregated content directory service. The subset is selected based on the identifier submitted to the aggregated content directory service.

In another embodiment of the present invention, a computer-readable medium has instructions stored thereon which are executable by a data processing arrangement capable of being coupled to a network. The instructions are executable for: gathering, from a plurality of media servers coupled to the network, content listings that describe content available via the associated media server; accepting, via the network, requests for content listings from one or more control point devices coupled to the network; selecting a subset of the content listings based on an identity associated with the control point devices; and presenting, to the control point devices via the network, an aggregated content listing based on the selected subset of the content listings.

In another embodiment of the present invention, a computer-readable medium has instructions stored thereon which are executable by a data processing arrangement capable of being coupled to a network. The instructions are executable for: selecting an identifier usable for accessing an aggregated content directory service and requesting an aggregated content listing from aggregated content directory service. The aggregated content listing containing entries gathered from a plurality of media servers. A subset of the aggregated content listing is received at the data processing arrangement. The subset selected based on the identifier submitted to the aggregated content directory service.

In another embodiment of the present invention, a system includes at least one control point device capable of being coupled to an ad-hoc peer-to-peer network and a plurality of media servers capable of being coupled to the network. The system also includes: means for gathering content listings from the plurality of media servers, each content listing describing content available via the associated media server; means for selecting a subset of the content listings based on an identity associated with the control point device; and means for presenting an aggregated content listing to the control point device. The aggregated content listing is based on the selected subset of the content listings.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a logical diagram of a content distribution environment according to embodiments of the present invention;

FIG. 2A illustrates a simple aggregation of CDS entries according to embodiments of the present invention;

FIG. 2B illustrates an alternate scheme for aggregating CDS entries according to embodiments of the present invention;

FIG. 3A illustrates an arrangement utilizing user profiles in conjunction with an aggregated CDS according to embodiments of the invention;

FIG. 3B illustrates use of a preferences module to modify CDS presentation according to embodiments of the present invention;

FIG. 4 illustrates an example of transforming and adding supplementary data to CDS entries according to embodiments of the present invention;

FIG. 5 illustrates an aggregated CDS that caches a subset of media server entries according to embodiments of the present invention;

FIG. 6 shows an example computing structure suitable for providing content gateway functionality according to embodiments of the present invention;

FIG. 7 illustrates a representative mobile computing arrangement capable of carrying out operations in accordance with embodiments of the present invention;

FIG. 8 is a flowchart showing steps in building an aggregated CDS according to embodiments of the present invention; and

FIG. 9 is a flowchart showing steps in providing aggregated CDS data to a control point according to embodiments of the present invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present invention provides an efficient and user-friendly searching for content among multiple devices coupled via a wireless network. Systems, methods and apparatuses are described for a content search framework that provides content aggregation in the network. Thus, the invention provides, among other things, a framework that enables a user to locate and consume (e.g., view, hear, or otherwise perceive) content on a network, such as a home network.

For example, the invention facilitates searching for content that may be stored or otherwise associated with communication devices, servers, consumer electronics devices and other devices and systems that can communicate via a peer-to-peer home/office network(s). One aspect of the invention involves a content search service to improve the user experience, lower response times, and otherwise improve the overall quality of content browsing by minimizing or eliminating the need to specifically identify and access data throughout the network.

The mobile device will utilize this content search service to efficiently search the content simultaneously on multiple servers. This service can provide all content distributed within multiple servers to appear in the mobile device as a single content directory service where the user can browse by content, title, etc and when requesting the specific item the service translate the query into the right message to the concrete server that contains the selected content. The content can be physically located on separate media servers within the UPnP network or the content can be located outside the UPnP network but still accessible from the UPnP network (e.g. the user may have a virtual CDS pointing to a media server located in the Internet and accessible through the UPnP gateway or a proprietary GW from the content provider).

Among other things, the invention enables users to search for and consume content anywhere within reach of the network. This is accomplished by aggregating descriptors for all of the content in a single, commonly accessible location. Aggregating the content listings at a single location provides efficient mechanisms for reducing the need for system-wide queries, dealing with redundancies, providing for data reduction and centralized user profiles, presenting a uniform view of data, and many other advantages.

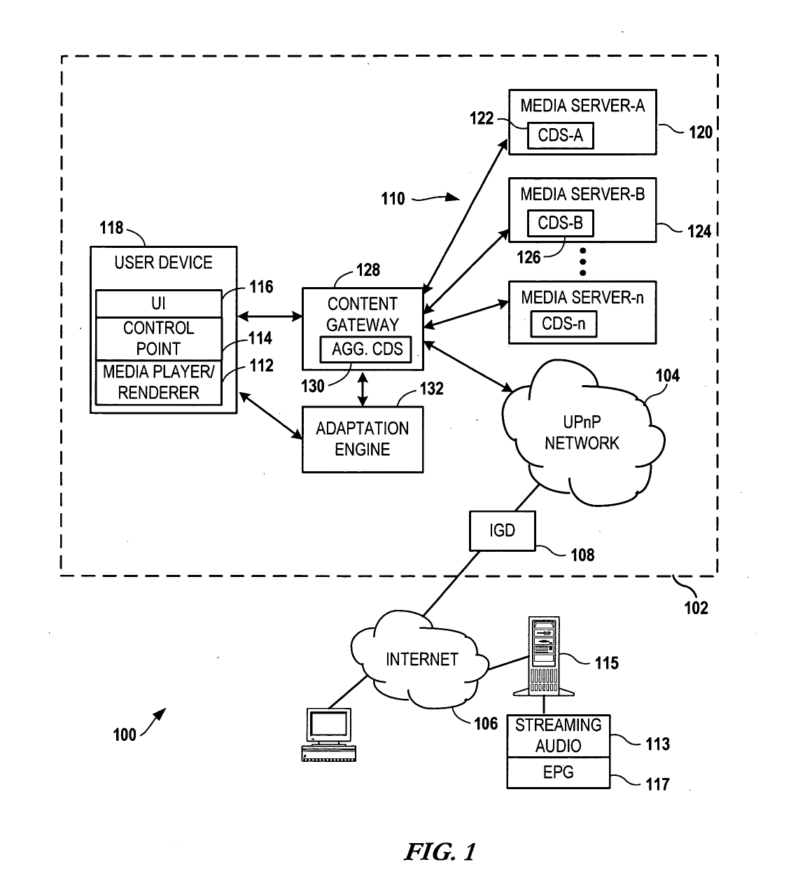

FIG. 1 is a logical diagram of a content distribution system 100 according to embodiments of the present invention. Generally, the system 100 includes a local networking environment 102. The local networking environment 102 is generally a collection of network elements located within a defined physical space. The local networking environment 102 may include, for example, one or more segments of a Universal Plug and Play™ (UPnP) network 104.

In order to facilitate an understanding of the invention, various aspects of the present invention may be described in the context of a UPnP networking environment. It will be appreciated, however, that the invention may be applicable in any system or application where ad-hoc data communications between devices such as consumer and mobile electronics is desired. For example, data transfer technologies such as X10, infrared data transfer, Ultra Wide Band (UWB), power line networking, zeroconf, Bluetooth, etc., may be with or instead of UPnP to provide some level of intercommunication in the local environment 102.

The local networking environment 102 may include any type of communication systems and networks, such as proximity and ad-hoc UPnP networks that are adapted for business and/or consumer use. The local networking environment 102 typically includes a home or office, although it will be appreciated that other environments may provide UPnP connectivity, including automobiles, airplanes, boats, public wireless hotspots, etc.

The UPnP network 104 is designed to facilitate simple and ubiquitous data transfer between a wide variety of devices. The UPnP framework includes a peer-to-peer Internet Protocol (IP) network environment that is independent of operating systems and architectures. A UPnP implementation may use various combinations of open Internet protocols, including HyperText transfer protocol (HTTP), eXtensible Markup Language (XML), Simple Object Access Protocol (SOAP), Simple Service Discovery Protocol (SSDP), and General Event Notification Architecture (GENA). Any data processing device can be UPnP-enabled, including PCs of all types, intelligent appliances, consumer electronics, and mobile/wireless devices.

Entities within the local environment 102 may have access to external networks such as the Internet 106. For example, a UPnP Internet Gateway Device (IGD) 108 may provide external network access to devices coupled to the UPnP network 104. The IGD 108 may include any network addressable device that resides at the edge of a UPnP network. The IGD 108 provides the UPnP network 104 with a WAN interface for accessing external network entities such as the Internet 106. The IGD 108 may also provide local addressing and routing services between one or more LAN segments and to and from the Internet.

The UPnP standard is designed to provide communications between a wide variety of devices. One branch of the UPnP specification deals in particular with Audio Video (AV) devices and communications. The UPnP AV specification is an adaptation of UPnP that allows consumer electronics devices to distribute digital entertainment content throughout a home/office network. UPnP AV deals with three specific logical entities, media servers 110, media renderers 112, and control points 114. Media servers 110 may include any manner of data processing arrangement that provides content to user devices on the UPnP network 104.

Media servers 110 can access entertainment content and provide that content on demand in a digitized format. The content provided by the media servers 110 may be stored on the device, or may be stored elsewhere. As an example of the latter case, a streaming audio service 113 may be provided by a server 115 coupled to the Internet 106. One of the media servers 110 may be able to access that audio server 115 via the IGD 108 and provide the audio to a locally coupled rendering device 112. In order to provide the audio signal to the local device 112, the media server 110 may perform transcoding, handling of digital rights managements, and other manipulations of the content.

Another example of remote content that may be made accessible by the media servers 10 is an Electronic Program Guide (EPG) service 117. An EPG service may be provided by a server 115 coupled to the Internet 106. Generally, the EPG service 117 provides a listing of content available from a local and/or remote content provider. For example, a cable television provider may have an Internet-accessible EPG service 117 that describes the local cable TV programs playing on a given day. The EPG service 117 may be accessed by a dedicated control/rendering device (e.g., a set top box) and may also be accessed by a general-purpose control device, such as a computer or “smart” remote control. Although the EPG service 117 may be accessed directly by a control point 114 and or rendering device 112, the EPG service 117 may be more useful to the UPnP network 104 if the EPG 117 is offered as a UPnP service by a media server 110.

Devices that act as media servers 110 may include music and video personal recorders (e.g., PVRs), home computers, digital playback devices (e.g., CD, DVD, DAT), network services (e.g., Internet radio), and similar devices. It will be appreciated, however, the media server 110 is a logical abstraction for use in UPnP AV networks, and any device capable of presenting data may be used as a media server 110.

The media renderers 112 are those devices that allow users to utilize and/or perceive data available on media servers 110. Typical media renderers include audio and video playback apparatus, although a media renderer 112 may perform any transformation and/or presentation of data that is useful to an end user. The interaction between the media servers 110 and media renderers 112 may be controlled by control points 114. Control points 114 typically provide a user interface 116 that can be manipulated by users to control aspects of data transfers on the UPnP network 104. Control points 114 can be used to select source and destinations for data, and may be used to control playback (e.g., pause, rewind), adjust playback (e.g., volume, brightness) and provide any other user-selectable function associated with data transactions.

It will be appreciated that the local networking environment 102 may support any number of media renderers 112 and control points 114. For purposes of illustration, a single end-user device 118 is shown that includes both the media renderer 112 and control point 114, as well as having a user interface 116. The user device 118 is adapted to access a plurality of media servers 110 via the UPnP network 104. In a typical UPnP network 104, the user device 118 may be able to directly access the media servers 110 in a peer-to-peer fashion. In particular, the user device 118 may be able to listen to and/or query the media servers 110 in order to discover content available on the servers 110. The task of enumerating content available on a UPnP media server 110 may be handled by a Content Directory Service (CDS) running on the server 110. For example, media servers 120, 124 may each include a respective CDS 122, 126 that allows devices to discover and use content stored on and/or accessible via the associated servers 120, 124.

The CDS allows the user device 118 (and other UPnP devices) to browse the content on the media servers 110 and obtain detailed information about individual content objects. The CDS is provided as a UPnP service template, identified as “urn:schemas-upnp-org:service:ContentDirectory:1,” where the numeral “1” signifies the latest version. The CDS specification uses an object-oriented classification of CDS accessible content. All CDS data items are derived from the “object” base class. The CDS specification also defines at two first level classes that directly inherit from “object.” The first of these first-level classes is known as an “item.” Items may include individual pieces of content such as songs and video clips. The other first-level class defined in the CDS specification is the “container” class. Containers may be used to represent collections of items, such as a playlists and photo albums. Nearly any type of content can be accessed and controlled via CDS using item and container objects. Many specific and useful content objects that provided by the CDS may inherit from these two first-level classes (e.g., “audioItem”).

The CDS provides lookup functions such as “browse” and “search” that allows devices to discover individual data objects stored on the media servers 110. The CDS also provides functions that allow inserting/creating new objects in the media servers 110. Once data objects have been located in the CDS, metadata included in the objects can be used for locating the content via a renderer device 112. For example, the metadata may include a Universal Resource Identifier (URI) that points to a file located on the media server. By using a standard content lookup method (i.e. the CDS), the processes of storing, retrieving, changing, and rendering digital content can be handled by many UPnP devices. The standards-based nature of UPnP allows these devices to successfully communicate such actions, even though the devices may be from different vendors and use different operating systems.

It will be appreciated that modern users may have a variety of sources that act as media servers 110. For example, media servers may include Personal Video Recorders (PVR) that stores televisions shows, a personal computer that stores a variety of data, and an MP3 player that stores music and is enabled to share the music over the UPnP network 104. One advantage of using UPnP media servers 110 is that the content stored in the media servers 110 can be accessed by a variety of devices in different locations throughout the local environment 102. Therefore, a user device 118 that is readily portable, such as a mobile phone or PDA, makes an ideal control point 114. In many cases, a portable user device 118 also makes an ideal rendering device 112.

In order for a portable user device 118 to access data from the media servers 110, then the device 118 must communicate with a plurality of CDS (e.g., CDS 122, 126). It will be appreciated that each CDS may contain references to thousands of content objects. The bandwidth and processing power consumed in accessing the CDSes from a portable user device 118 may be quite large if the device 118 must query a large number of servers, enumerate a large number of objects, and identify and/or merge redundant objects. Moreover, the user may not know and does not care in what specific server the content is located and requires doing an exhaustive search. The content aggregator provides a single view of the content in the UPnP network and performs the search in the virtual CDS while querying separately each of the media servers. Mobile communications devices typically have limited bandwidth and processing power compared to wired devices. Therefore, mobile devices may exhibit poor usability and performance if required to repeatedly access this large amount of data. In order for such devices to control the disposition of multimedia content via UPnP or similar networks, it is desirable to provide a way to efficiently communicate content directory data between the user device 118 and the media servers 110.

In the illustrated system, a content gateway 128 is used for more efficient communications of content directory data. The content gateway 128 is a single access point that may be used by a user device 118 to discover all the content available in the local environment. The content gateway 128 contains an aggregated CDS 130 that may store all or part of the CDS data provided by the media servers 110. The content gateway 128 may generally be considered a single logical entity, inasmuch as it provides a unified service. The content gateway 128 may be implemented as a standalone device, or as a peripheral or chipset that is added to an existing device. In some cases the content gateway can also be a logical component so a content gateway with a reduced functionality can also be located in the mobile device. The physical implementation of the content gateway 128 may also include multiple computing arrangements, such as redundant and distributed service arrangements. To the user device 118, however, the content gateway 128 appears as a single access point that may be used to discover and control content on the UPnP network 104.

The content gateway 128 generally builds and maintains the aggregated CDS 130 to reflect content available via the media servers 110. The content may be accessed directly for rendering from the media servers 110, or the content may be processed by some intermediate device, such as an adaptation engine 132. The adaptation engine 132 may provide such content related services as transcoding, upconverting/downconverting of bit rates, managing quality of service, altering transport protocols, etc. The access of content via the adaptation engine 132 may be handled system-wide, such as by setting up the adaptation engine 132 as proxy for all media access. In other arrangements, the aggregated CDS 130 may alter URI's that describe content location so that selected content may be accessed via the adaptation engine 132 rather than directly from the media servers 110.

The entries in the aggregated CDS 130 may be copied and/or referenced from the original entries in the media servers 110. The media servers 110 may be actively queried to discover content directory data. The entries in the aggregated CDS 130 may also be added and/or supplemented by passively listening to SSDP notify messages that are sent by the media servers 110. The content gateway 128 may use any combination of content discovery techniques to build the aggregated CDS 130.

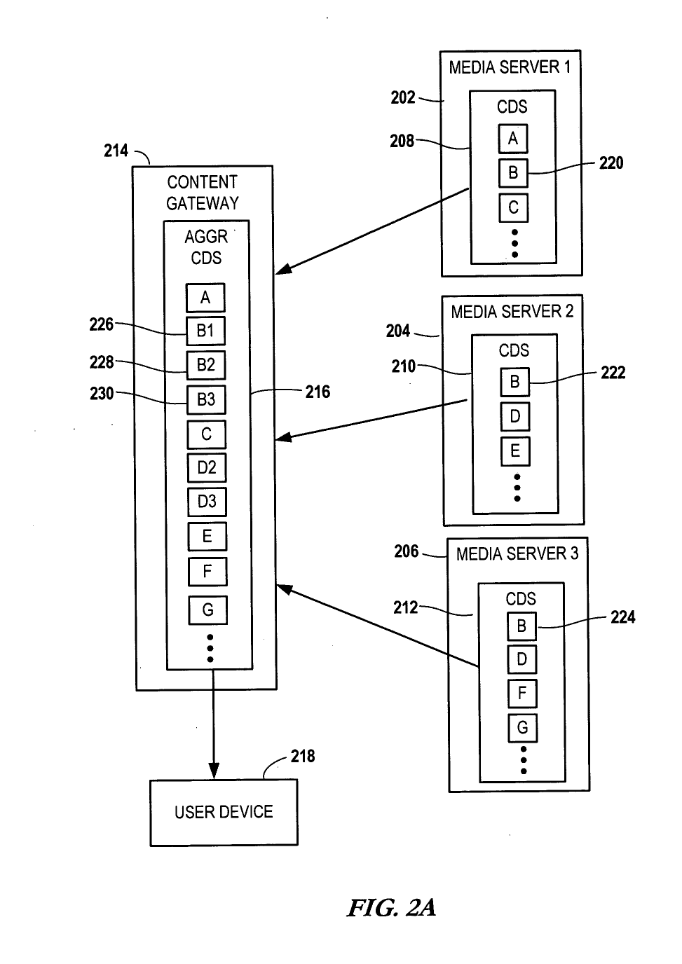

In reference now to FIG. 2A, a simple aggregation of CDS entries is shown according to embodiments of the present invention. In this example, three media servers 202, 204, 206 each include respective independently maintained CDSes, 208, 210, and 212. The content described by each CDS 208, 210, 212 may be included on the associated device 202, 204, 206, or may be accessed via the device 202, 204, 206 but stored elsewhere. A content gateway 214 collects entries from the CDSes 208, 210, 212 and combines them into an aggregated CDS 216.

The content gateway 214 may treat containers and items differently when forming the aggregated CDS 216. The container structures contained in the source CDSes 208, 210, 212 may be discarded, such that the aggregated CDS-216 contains only the items listed in the CDSes 208, 210, 212. Alternatively, the aggregated CDS 216 may replicate the entire container hierarchy of each CDS 208, 210, 212. For example, the top-level containers of each CDS 208, 210, 212 may be included as top-level containers in the aggregated CDS 216. In another variation, the aggregated CDS 216 may specially form a top-level container reserved for each media server 202, 204, 206. The CDS data from each media server 202, 204, 206 can then placed in the respective top-level container on the aggregated CDS 216. The underlying container hierarchy of the associated CDS 208, 210, 212 may or may not be preserved in the respective top-level containers of the aggregated CDS 216.

In many situations, it is possible that two or more media servers will include entries that are similar or identical. The aggregated CDS 216 may use various schemes to deal with identical data entries available from the separate CDSs 208, 210, 212. For the purposes of the following discussion, it will be assumed that the CDSs 208, 210, 212, 216 contain only items. However, it will be appreciated that containers may be combined and merged into the aggregated CDS using the principles described for items.

In the illustrated example, it is assumed entries 220, 222, and 224 in respective media servers 202, 204, and 206 are identical. The similarity or equality of CDS entries may be defined in many different ways. In some situations, factors such as user preferences, design objectives, and the type of media involved, may require different definitions of similarity/identity. Similarity can be determined by comparing any combination of titles, source filenames, URIs, time stamps, file sizes, hash values, external database identifiers such as CDDB™, etc. If the entries are containers, then the container name, contents, and hierarchical location may be relevant characteristics to consider when merging CDS entries.

The aggregated CDS 216 in FIG. 2A uses a simple combination to deal with identical/redundant data. For example, the identical entries 220, 222, 224 are presented as entries 226, 228, and 230, respectively, in the aggregated CDS 216. The entries may be presented to the user device 218 using identical titles and/or metadata, or the entries may include notations to make it clear that seemingly identical entries originate from different media servers.

The aggregation scheme in FIG. 2A provides the greatest amount of control over CDS content, because the user device 218 can theoretically access every entry of every media server 202, 204, 206. However, as library sizes grow in the home network, a greater premium may be placed on ease of use rather than on amount of control. An important aspect in providing ease of access is to reduce the number of choices the user is faced with. Therefore, if the user wants to hear a particular song, the user may not care from which media server the song originates. A CDS aggregation scheme that provides easier user access according to embodiments of the present invention is shown in FIG. 2B.

The composition of media servers 202, 204, 206 and respective CDSs 208, 210, and 212 may be substantially the same in FIG. 2B as in FIG. 2A. However, a different aggregated CDS 232 merges identical entries before presenting those entries to the user device 218. For example, identical entries 220, 222, and 224 are presented as a single entry 234. The content gateway 214 may still keep local references 226, 228, and 230 to the duplicate entries 220, 222, 224, but these references 226, 228, 230 are hidden from the user.

When merging entries into the aggregated CDS 232 as shown, the content gateway 214 will need to choose which internal reference 226, 228, 230 is presented to the user device 218 during a browse or search of the CDS 232. The content gateway 214 may track statistics of the media servers 202, 204, 206, so that factors such as server up-time and bandwidth may be used to determine the best reference 226, 228, 230 to use as the single CDS entry 234. The content gateway 214 will also need to maintain states of internal references 226, 228, 230. For example, if the entry 222 is deleted from music server 204, the associated reference 228 is deleted by the content gateway. If deleted internal reference 228 was used to represent the single entry 234, then one of the other reference 226, 230 will be used as the single entry 234.

It will be appreciated that merging redundant data entries in the content gateway 214 may also help reduce bandwidth usage by the user device 218. For example, if the user device 218 were required to connect to each separate CDS 208, 210, 212, then each time the content changed in those CDSs 208, 210, 212, the user device 218 may need to be informed via an SSDP multicast message. However, if the changed content is redundant with content on another media server, then these changes may not need to be communicated to the user device 218. Using the previous example, if entry 222 is deleted from music server 204, and associated internal reference 228 is not being used by the aggregated CDS 232 as the single entry 234, then there is no need to communicate this deletion to the user device 218.

Merging redundant CDS data is one way of reducing the amount of data presented to the user of a UPnP control point. However, the size of an aggregated CDS that gathers entries from multiple media servers may still be too large to be easily dealt with by many control point devices, even when duplicate entries are merged. In many applications, the ideal control point device will be small, portable, and use a wireless data connection. Such a portable device has clear advantages in a ubiquitous computing environment. However, such devices also have small readouts, limited space for buttons and controls, and have limited network and processing bandwidth. Therefore, it is desirable to further limit the amount of CDS data sent to such a device via a content gateway.

One way to limit the amount of data sent to a control point is to realize that not all data accessible on a UPnP or similar network needs to be accessed by every control point. For example, where the control point is a PDA or cellular phone, the user may only be interested in receiving a certain type of data such as digital audio. Therefore, where a user has an extensive digital video collection in addition to digital audio, there is no point in presenting the video data when the control point accesses the aggregated CDS. Also, if some of the audio files are encoded at a data rate that exceeds the wireless bandwidth of the renderer (and assuming no intermediary is available to resample the audio stream), there may be no point in presenting these files via the CDS if the renderer cannot use them. For these and other reasons, there may be an advantage in storing customized profiles on the content gateway. The custom profiles can be used to tailor data presented to user devices via the aggregated CDS.

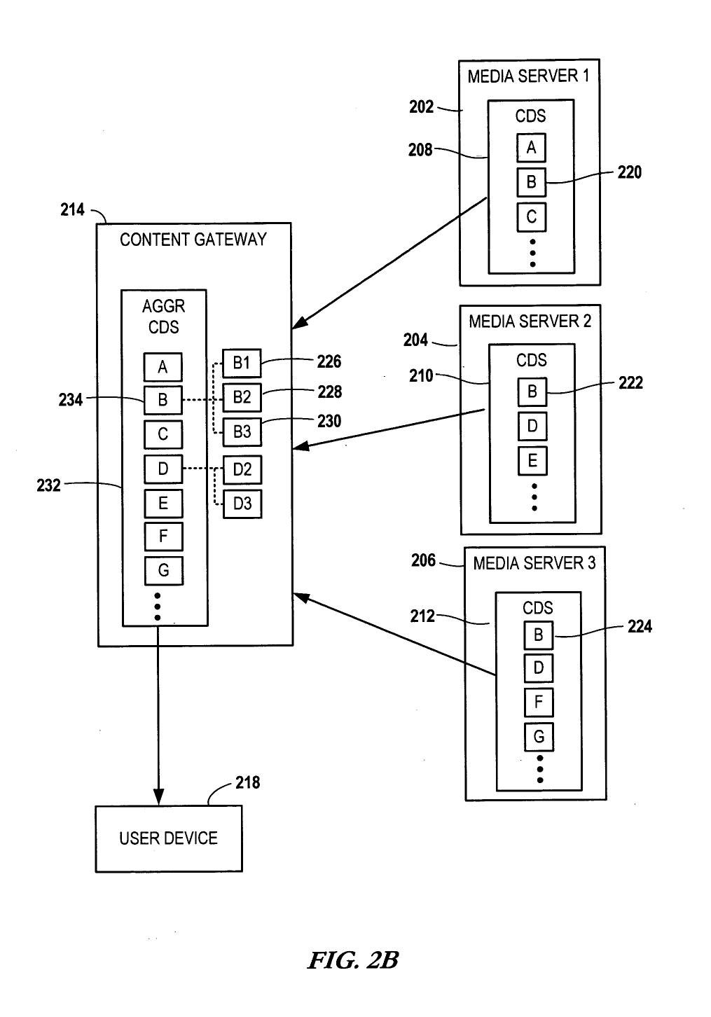

An arrangement that utilizes user profiles in conjunction with an aggregated CDS according to embodiments of the invention is shown in FIG. 3A. A content gateway 302 includes an aggregated CDS 304 that can provide a combined listing of content objects available via media servers on a UPnP network. The aggregated CDS 304 may be accessed by multiple user devices, as represented by user devices 306 and 308. The user devices 306 and 308 may at least include a UI and UPnP control point, and may also have dedicated rendering hardware.

The content gateway 302 includes a preferences module 310 for storing, accessing and using preferences associated with various control point devices. In the illustrated example, preference setting 312 is associated with user device 306. User device 308 has two preference settings 314 and 316 in the preferences module 310. The preferences 314, 316 associated with user device 308 are linked to respective modes 318, 320 of the device 308. The modes 318, 320 may be related to separate applications, users, states, hardware configuration, software configuration, or any other aspect related to the device's access of data from the aggregated CDS 304.

The preferences module 310 generally interacts with the aggregated CDS to limit the amount of data presented to selected devices when those devices browse or search the CDS. For example, the preference 312 associated with device 306 results in, at most, CDS entries 322, 324, and 326 being exposed to the device. So a browse action initiated by the user device 306 results, at most, in the illustrated subset 328 being enumerated. Similarly, the subsets 330 and 332 my be presented to device 308 depending on whether the device 308 is utilizing mode 318 or mode 320, respectively.

The preferences module 310 may restrict/allow exposure of CDS entries based on any combination of device characteristics. For example, the modes 318, 320 of user device 308 may relate to different rendering devices of the device. Mode 318 may be related to the use of an audio renderer and mode 320 may be related to an audio/video renderer. In another example, the modes 318, 320 may apply to different users. It may be desirable, for example, to automatically restrict the ability of certain users (e.g., children) to access particular items on the aggregated CDS 304. These restrictions may be applied manually (e.g., incorporating restriction lists into the preferences module 310) or automatically (e.g., content ratings contained in the CDS entries).

Other usage scenarios may also take advantage of the preferences module 310 to limit CDS data exchanges. For example, assume the user device 306 is a portable audio renderer with the capability to display static images (e.g., photos). If the user would like to generate random playlists of music and pictures, this might involve downloading song and photo lists to the device 306, then randomizing that list for playback. If the lists contained entries for 5,000 songs and 3,000 pictures, the lists may require a long download time, and take prohibitive amounts of memory to store. Instead, the profile 312 associated with the device 306 may configured so that, on a browse action, a small, randomly generated list (e.g., five songs and five pictures) was presented to the device 306. To provide a truly random playback of the entire aggregated CDS 304, the user device 306 could simply perform a new browse of the CDS to obtain a small list of “now playing” and “up next” songs and pictures. The device 306 could occasionally repeat the browse action to add to the list as needed. The content gateway 302 may be configured to keep track of current context (e.g., history) to ensure that repetitions do not occur when serving up the randomized lists.

The preferences module 310 may be also be used to modify the data sent to devices via the aggregated CDS 304. The use of the preferences module 310 to modify CDS presentation according to embodiments of the present invention is shown in FIG. 3B. The preferences module 310 contains additional preferences data 312B and 314B associated with user devices 306 and 308, respectively. The preferences data 312B and 314B may include transformation data used to control the format of object descriptions retrieved from the aggregated CDS 304.

The preferences data 312B and 314B data may also include supplementary data that is added to content objects of the aggregated CDS 304, such as supplementary data 336 and 338 associated with object 322. For example, if object 322 describes a song, supplementary data 336 may contain lyrics for a text readout of device 306, and supplementary data 338 may contain a reference to album cover art for use by a video display of device 308. The preferences data 312B and 314B may include any combination of formatting and supplementary data that exists in both the form of preference-specific rules and object-specific supplemental data.

As an example of formatting rules, the preferences module 310 may truncate titles, strip certain characters, limit data size of object descriptions, change case of characters, etc. These rules could be defined once for a device and applied to all CDS accesses by that device. The supplementary data may be manually or automatically generated and associated with CDS entries. For example, users manually may rate songs (e.g., one to five stars) based on their preferences. Each song would have an associated rating value placed in the data store 334. Each time the song's metadata is accessed, the associated rating may be retrieved from the data store 334 by the preferences module 310 (or other software) and provided in listings by the aggregated CDS 304.

Supplementary data could also be automatically generated and associated with CDS entries. For example, graphics files containing album cover art may be associated with stored music files. The association between music and graphics files may be embedded in the music files, or entered in a database. Each time a song is accessed, the preferences module 310 may use these associations to create an entry in the song's CDS metadata that points to the appropriate album cover art. In this way, the music can be seamlessly synchronized with album art during playback. This synchronization can be implemented in the content gateway 302 even if the media servers that contain the music and/or album art do not support this feature.

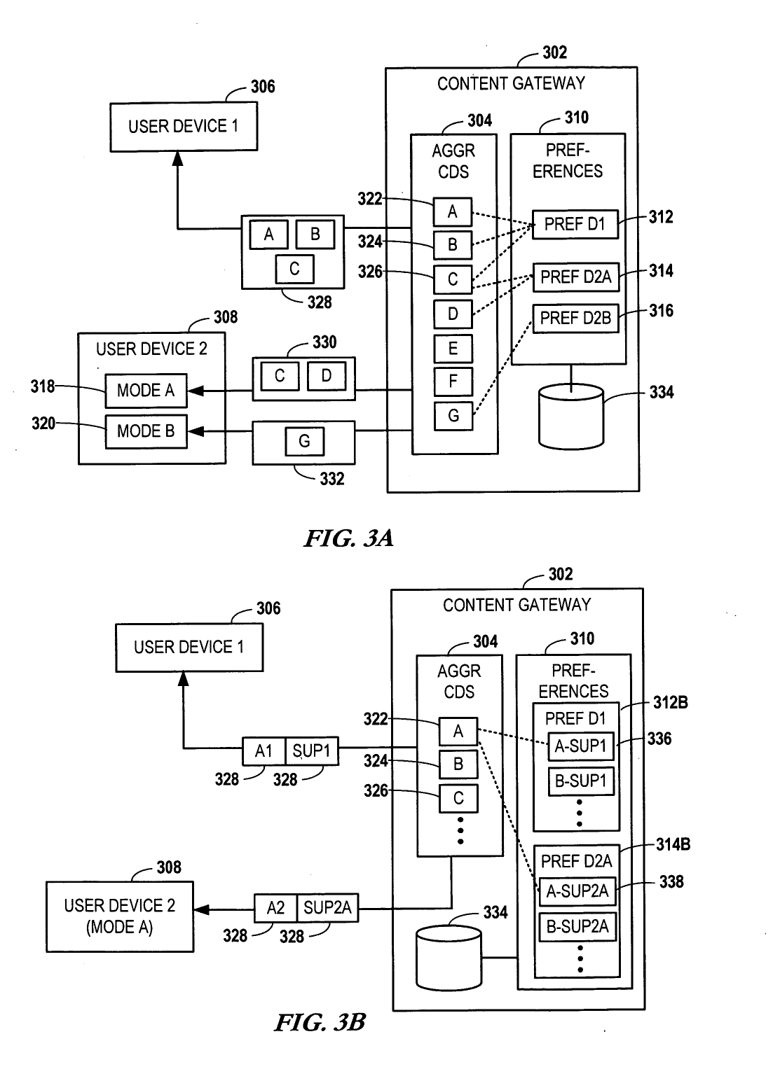

A more detailed example of transforming and adding supplementary data according to embodiments of the present invention is shown in FIG. 4. In this example, a content gateway 402 receives CDS entries from three media servers 404, 406, and 408. An aggregated CDS 410 merges data from the media servers 404, 406, 408 and presents that data in a consistent format to a user device 412. Presenting data in a consistent format may include any combination of adding to, subtracting from, or modifying data elements associated with entries/objects in the aggregated CDS 410.

In this example, the CDS entries are all audio items, and in particular music tracks. Each of the media servers 404, 406, 408 has as different way of scoring user ratings that have been attached to the music tracks. Media server 404 uses a “userRating” description 414, which utilizes an integer from 1 to 100 to represent ratings as a percentage. Media server 406 uses a “starRating description 416, which is an integer from 1 to 5. Media server 408 does not provide user ratings at all.

It will be appreciated that there may be benefits in providing a uniform view of metadata such as user ratings to the user device 412. The end user may want to use these ratings in forming playlists, filtering random tracks, etc. The user may also want to add to or modify the ratings during playback. However, if different media servers use different rating schemes, then this task becomes complicated. Normally, the user would have to manually change each rating in the respective media server. However, the content server 402 may be configured to store separate ratings in a supplementary data store 418. The supplementary data store 418 can be used to present content ratings to the user device 412 in a consistent format, and may also be configured to translate between various ratings systems used on the media servers 404, 406, 408.

The ratings stored in the supplementary data store 418 can be adapted to any scheme desired by the user and/or appropriate for the user device 412. A user preferences/transforms database 420 can be used to analyze various rating schemes and apply the appropriate transformations. In this example, the CDS listing 422 produced by the aggregated CDS 410 includes a “uniformRating” value that is an integer from 1 to 10. So, the rating 414 from media server 404 is transformed from a “60” to a “6,” as shown in the element 424. The transformed entry of “Song3” from media server 408 includes a “uniformRating” element 426 with value set to “−1,” indicating that this rating has not been entered (other values may also be used to indicate rating not entered, such as zero or a string). If the user later modifies this rating 426 via the user device 412, then the new rating value can be stored in the supplementary data store 418. Thereafter, the new rating can be retrieved on subsequent accesses to the aggregated CDS 410. Changes to the other rating 424 would also be changed in the data store 418. In this latter case, the rating is also maintained on the media server 404. Therefore, changes made by at the user device 412 may also be applied to the originating media server 404 using an inverse transform determined from the transform database 420.

The transformation and storage of supplementary data as described in FIG. 4 may be applied to any metadata in the aggregated CDS 410. Such modified/supplemented metadata may include titles, authors, network pathnames, URIs, etc. The transformation module 420 may also remove unused or unwanted elements from CDS entries, for purposes of consistency, preventing malformed XML documents, reducing bandwidth, etc.

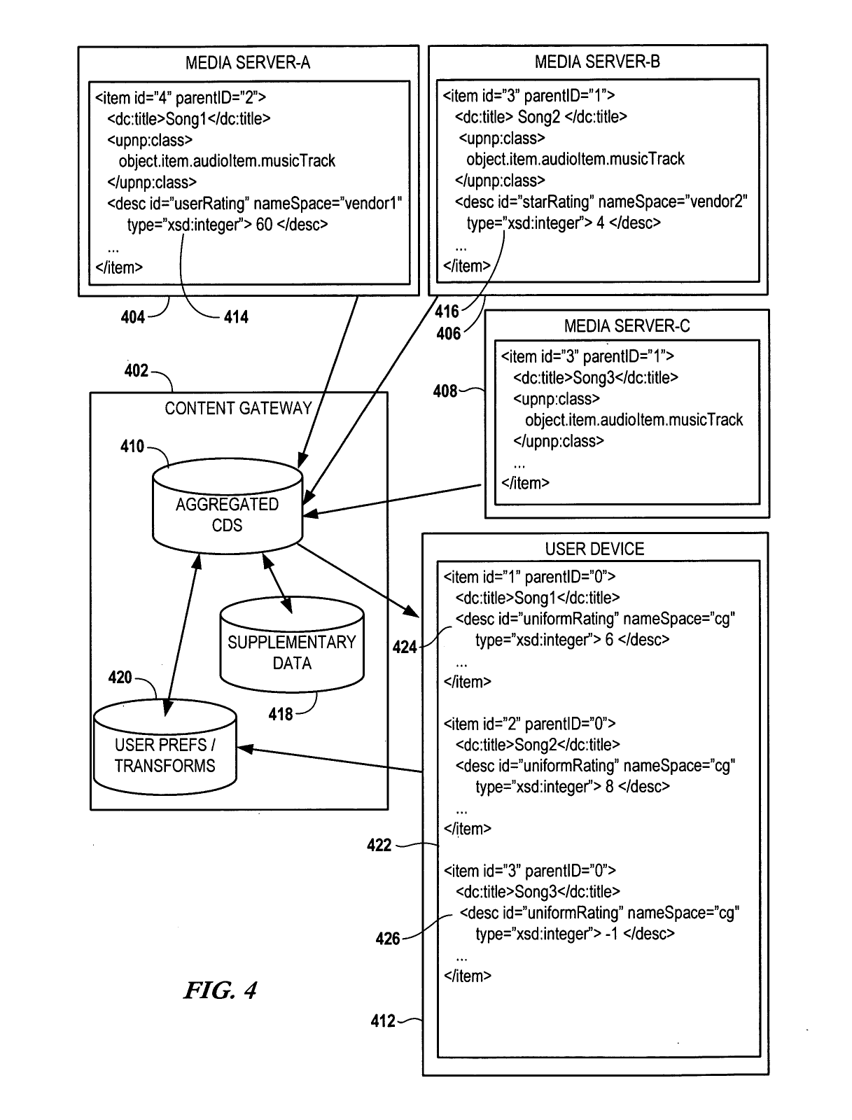

In above examples, it may be assumed that the aggregated CDS collects and stores/references all entries from local media servers. However, it will be appreciated that in some arrangements, the aggregated CDS will cache only a subset of media server entries. An aggregated CDS 500 that caches only a subset of media server entries according to embodiments of the present invention is shown in FIG. 5. The aggregated CDS 500 is included in a content gateway 502 that connects to multiple media servers 504, 506, and 508. The media servers 504, 506, 508 include respective CDSs 510, 512, 514.

When accessing the CDSs 510, 512, 514, the content gateway 502 utilizes a preferences module 516 to determine whether or not to cache entries from the media servers 504, 506, 508. A persistent storage 518 may be accessed by the preferences module 516 to determine which entries to cache. Any entries that are selected for caching by the preferences module 516 are placed in the aggregated CDS 500. Therefore the aggregated CDS 500 includes a subset of entries available from the media servers 504, 506, 508. For example, the aggregated CDS does not cache the entry 520 available from the media server 504.

The entire subset of entries in the aggregated CDS 500 can be presented to a user device 522, or smaller subsets may be presented based on the preferences module 516. The aggregated CDS entries can be presented without changes, or transformations can be applied to the aggregated CDS entries before presenting the entries to the user device 522 as described hereinabove. Similarly, preferences associated with the user device 522 may also be used to further limit/control the presentation of duplicate CDS entries to the device 522.

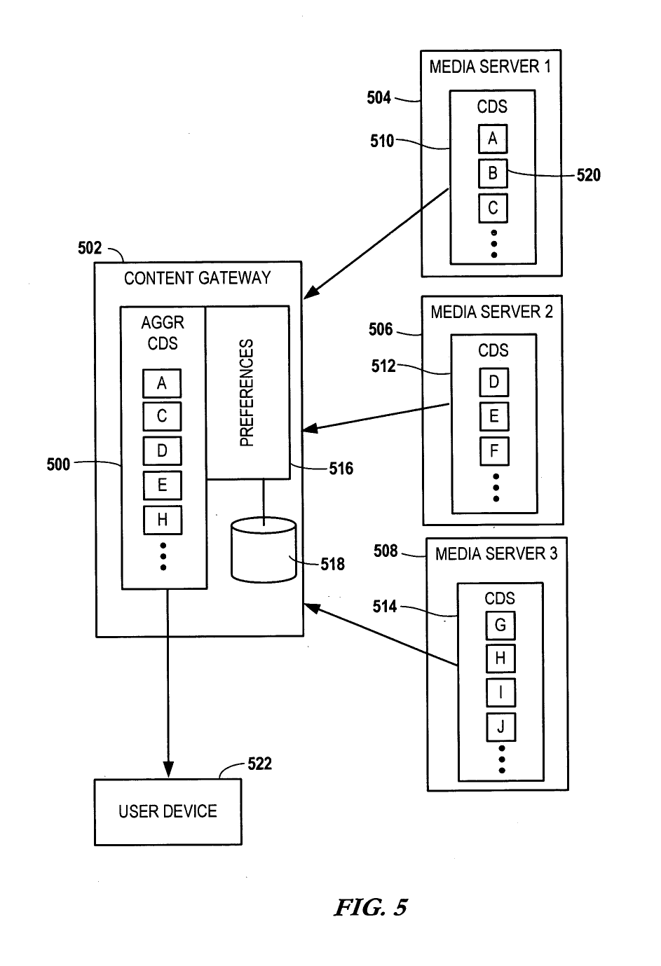

The content gateway 502 may be implemented using any combination of hardware and software known in the art. The content gateway 502 may be implemented as a standalone device, a chipset, a processor-implemented service, or be included as part of other electronic equipment, including computers, routers, wireless access points, set-top boxes, etc. FIG. 6 shows an example computing structure 600 suitable for providing content gateway functionality according to embodiments of the present invention.

The computing structure 600 includes a computing arrangement 601. The computing arrangement 601 may include custom or general-purpose electronic components. The computing arrangement 601 includes a central processor (CPU) 602 that may be coupled to random access memory (RAM) 604 and/or read-only memory (ROM) 606. The ROM 606 may include various types of storage media, such as programmable ROM (PROM), erasable PROM (EPROM), etc. The processor 602 may communicate with other internal and external components through input/output (I/O) circuitry 608. The processor 602 carries out a variety of functions as is known in the art, as dictated by software and/or firmware instructions.

The computing arrangement 601 may include one or more data storage devices, including hard and floppy disk drives 612, CD-ROM drives 614, and other hardware capable of reading and/or storing information such as DVD, etc. In one embodiment, software for carrying out the operations in accordance with the present invention may be stored and distributed on a CD-ROM 616, diskette 618 or other form of media capable of portably storing information. These storage media may be inserted into, and read by, devices such as the CD-ROM drive 614, the disk drive 612, etc. The software may also be transmitted to computing arrangement 601 via data signals, such as being downloaded electronically via a network, such as the Internet. The computing arrangement 601 may be coupled to a user input/output interface 622 for user interaction. The user input/output interface 622 may include apparatus such as a mouse, keyboard, microphone, touch pad, touch screen, voice-recognition system, monitor, LED display, LCD display, etc.

The computing arrangement 601 may be coupled to other computing devices via networks. In particular, the computing arrangement includes a network interface 624 for interacting with a UPnP network 626. The network interface 624 may include hardware and software components, including drivers, programs, and protocol modules. The network interface 624 is utilized by a CDS gathering module 628 and an aggregated CDS module 632 that is configured to perform data transfers via the UPnP network 626.

The memory of the computing arrangement 601 may be used to store processor executable instructions for carrying out tasks of the CDS gathering module 628 and an aggregated CDS module 632. For example, the CDS gathering module 628 is configure to connect to a plurality of media servers 632 via the UPnP network 626, as represented by the path 634. The CDS gathering module 628 collects, monitors, and modifies CDS data entries of the respective media servers 630. This CDS data may be collected from the media servers 630 using the standard CDS access functions (e.g., browse, search). CDS data entries collected by the CDS gathering module 628 are used by the aggregated CDS module 632.

The aggregated CDS module 632 builds, maintains, and distributes content metadata to control/renderer devices 636, as represented by the path 638. The aggregated CDS 632 may utilize a standard CDS service interface, or implement a customized UPnP service. For example, the aggregated CDS 632 may advertise an “aggregatedCDS” service that is substantially similar to the standard CDS service, but acts as a single connection point for all content directory services. The control/renderer devices 636 may include additional or alternate control point interfaces that are able to utilize this custom UPnP service.

The services provided by the aggregated CDS 632 may include extensions not available in the standard CDS. For example, browse and search functions may be work similar to the CDS counterparts. However, the aggregated browse and search may allow passing in of a profile identifier 640 used to identify a particular entity. The profile identifier 640 may be used by a preferences/transformation module 642 to tailor the entries delivered to the control/renderer devices 636. The profile identifier 640 may identify any combination of devices, modes, users, and other characteristics relevant to tailoring data provided by the aggregated CDS 632.

The profile identifier 640 may be linked to a profile object 644 that is maintained and accessible by the aggregated CDS 632 and the preferences/transformations module 642. The profile identifier 640 may be a required or optional parameter for access functions (e.g., browse) of the aggregated CDS 632. The profile identifier 640 and profile object 644 may also be used by the CDS gathering module 628. For example, in configurations where the aggregated CDS 632 caches only a subset of available media server data, the CDS gathering module 628 may limit the data that is searched and/or transferred into the aggregated CDS 632 based on the profile object 644 and/or preferences module 642.

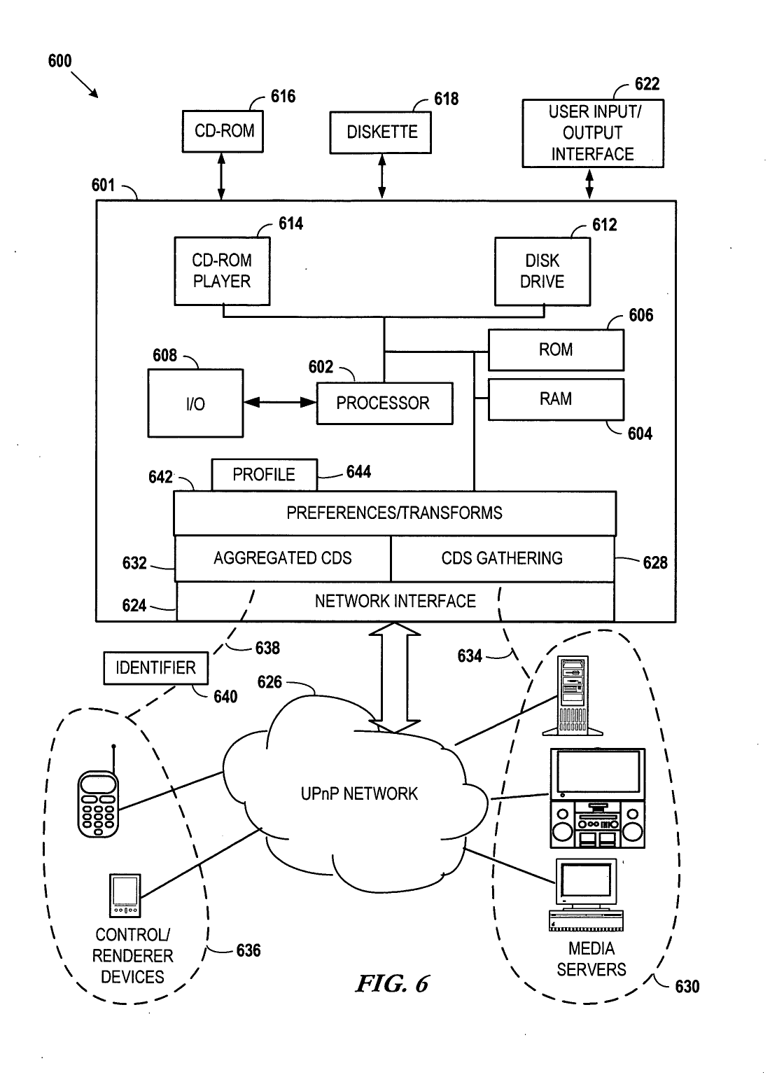

Many types of apparatuses may be able to perform roles as media servers, media renderers, and control points on a UPnP network. Mobile devices are particularly useful as control points, and may also be used as media servers and renderers. In reference now to FIG. 7, an example is illustrated of a representative mobile computing arrangement 700 capable of carrying out operations in accordance with embodiments of the invention. Those skilled in the art will appreciate that the exemplary mobile computing arrangement 700 is merely representative of general functions that may be associated with such mobile devices, and also that landline computing systems similarly include computing circuitry to perform such operations.

The illustrated mobile computing arrangement 700 may suitable at least for performing roles as both a media renderer and a control point in a UPnP AV network. The mobile computing arrangement 700 includes a processing/control unit 702, such as a microprocessor, reduced instruction set computer (RISC), or other central processing module. The processing unit 702 need not be a single device, and may include one or more processors. For example, the processing unit may include a master processor and associated slave processors coupled to communicate with the master processor.

The processing unit 702 controls the basic functions of the arrangement 700. Those functions associated may be included as instructions stored in a program storage/memory 704. In one embodiment of the invention, the program modules associated with the storage/memory 704 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The program storage/memory 704 may also include operating systems for carrying out functions and applications associated with functions on the mobile computing arrangement 700. The program storage 704 may include one or more of read-only memory (ROM), flash ROM, programmable and/or erasable ROM, random access memory (RAM), subscriber interface module (SIM), wireless interface module (WIM), smart card, hard drive, or other removable memory device.

The mobile computing arrangement 700 includes hardware and software components coupled to the processing/control unit 702 for performing network data exchanges. The mobile computing arrangement 700 may include multiple network interfaces for maintaining any combination of wired or wireless data connections. In particular, the illustrated mobile computing arrangement 700 includes wireless data transmission circuitry for performing network data exchanges.

This wireless circuitry includes a digital signal processor (DSP) 706 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 708, generally coupled to an antenna 710, transmits the outgoing radio signals 712 and receives the incoming radio signals 714 associated with the wireless device.

The mobile computing arrangement 700 also includes a UPnP hardware interface 716 coupled to the processing/control unit 702. The UPnP hardware interface 716 may include the ability to communicate on a UPnP network using any manner of data transmission medium, including wired and wireless mediums. The processor 702 is also coupled to user-interface 718 elements associated with the mobile terminal. The user-interface 718 of the mobile terminal may include, for example, a display 720 such as a liquid crystal display, a keypad 722, speaker 724, and microphone 726. These and other user-interface components are coupled to the processor 702 as is known in the art. Other user-interface mechanisms may be employed, such as voice commands, switches, touch pad/screen, graphical user interface using a pointing device, trackball, joystick, or any other user interface mechanism.

The storage/memory 704 of the mobile computing arrangement 700 may include software modules for communicating over a UPnP network. In particular, one or more applications 728 may allow the mobile computing arrangement 700 to act as a UPnP renderer and/or control point. Access to elements of the UPnP network is provided via a UPnP data interface 730. The applications 728 and UPnP data interface 730 are configured to utilize an aggregated CDS. The specialized functions that may be required to access the aggregated CDS may be provided at least in part by an aggregated CDS access module 732.

The aggregated CDS access module 732 includes the capability to discover and utilize an aggregated CDS. The aggregated CDS module 732 may be enabled to search for logical UPnP devices that are advertising an aggregated CDS service. Once the service is discovered, the aggregated CDS module 732 may work in concert with a control point application 728 to obtain content listings. The aggregated CDS module 728 may also communicate preferences/transforms to be utilized by the mobile computing arrangement 700. The handling of aggregated preferences may involve tasks such as providing a user interface for setting user preferences, checking system states/modes that may affect preferences, handling transitions/conflicts between connecting to a standard CDS and connecting to an aggregated CDS, etc. The mobile computing arrangement 700 of FIG. 7 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

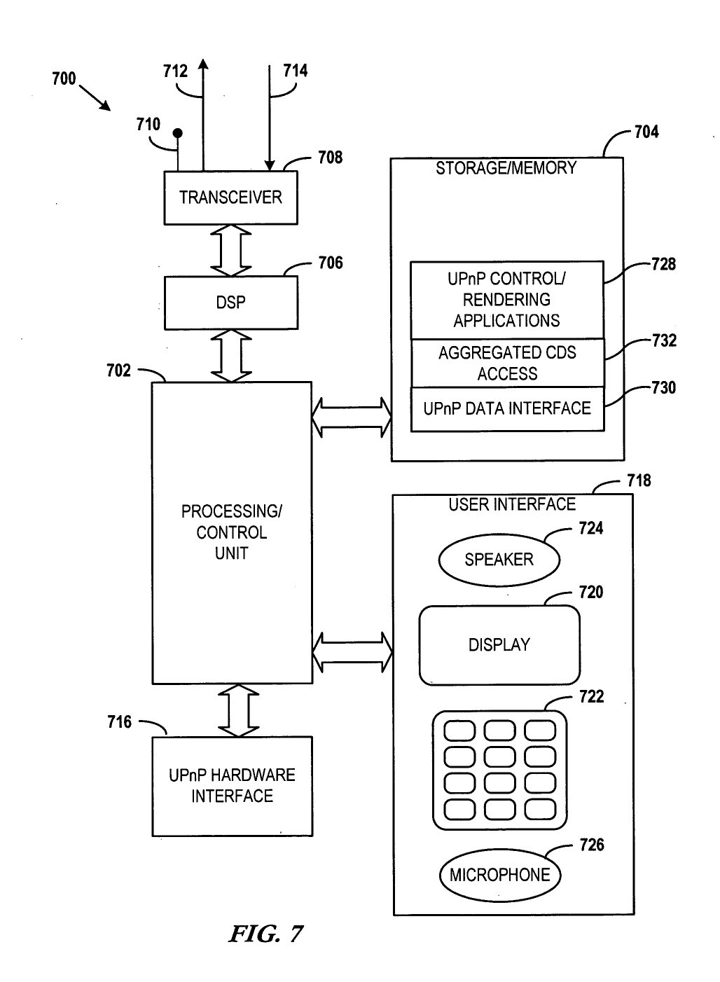

A procedure 800 for building the data used in an aggregated CDS according to embodiments of the present invention is shown in FIG. 8. The procedure involves gathering (802) content listings from a plurality of media servers. These content listings may be actively queried using CDS access methods and/or be passively added/updated based on update messages originating from the media servers. The aggregated CDS may resolve (804) duplicate entries. For example, the aggregated CDS may simply ignore duplicate entries, add all entries but add differentiating data to duplicate entries, present duplicates as a single entry, etc. After the initial aggregated CDS is built, the data may be update through continuous listening/querying (806) for changes followed by updates (808) to the aggregated CDS based on those changes.

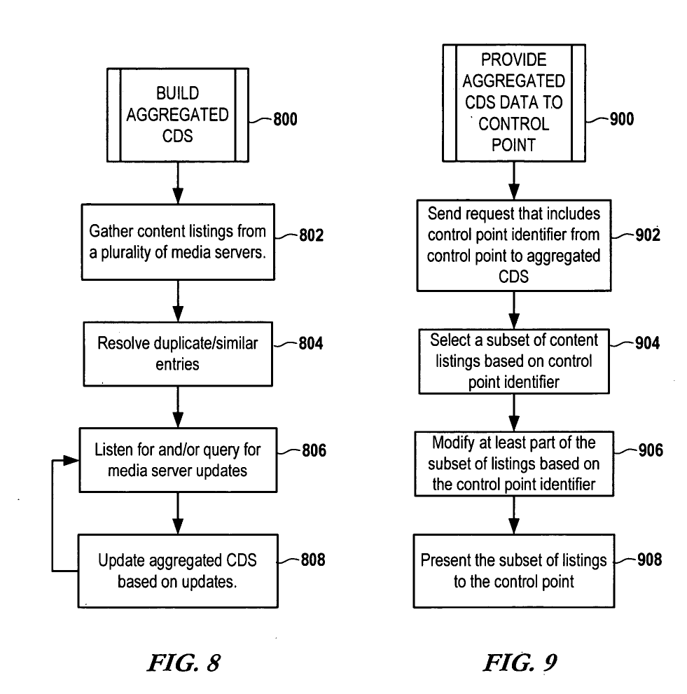

A procedure 900 for providing aggregated CDS data to UPnP control points according to embodiments of the present invention is shown in FIG. 9. Typically, the procedure will involve a request (902) from a control point to a device advertising an aggregated CDS service. This request (902) may include an identifier associated with the originating control point. Based on the request (902) a subset of content is selected (904) for presentation based on the control point identifier. This selection (904) may occur dynamically to a CDS that includes all available CDS entries from the UPnP network. The selection (904) may also have occurred prior to the request, such as when the aggregated CDS includes a selective cache of entries.

The aggregated CDS may also modify (906) the selected entries. This modification (906) may include adding, deleting, changing, or otherwise transforming the data included in the CDS. The modification (906) may be for purposes of providing consistent CDS objects/entries, and may also be used to add custom features to the aggregated metadata. Finally, the subset of listings is presented (908) to the requesting control point.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method of providing access to content in an ad-hoc peer-to-peer network, comprising:
gathering, from a plurality of media servers coupled to the network, content listings that describe content available via the associated media server;
selecting a subset of the content listings based on an identity associated with a control point device; and
presenting, to the control point device, an aggregated content listing based on the selected subset of the content listings.

2. The method of claim 1, further comprising placing all of the content listings gathered from the media servers into the aggregated content listing.

3. The method of claim 1, further comprising placing only the selected subset of the content listings into the aggregated content listing.

4. The method of claim 1, further comprising modifying at least a portion of the aggregated content listing so that the subset of content listings is in a consistent format.

5. The method of claim 4, wherein modifying at least a portion of the aggregated content comprises removing elements from the content listings.

6. The method of claim 4, wherein modifying at least a portion of the aggregated content comprises adding elements to the content listings.

7. The method of claim 6, further comprising storing supplemental data related to the content listings in a database separate from the content listings of the media servers, and wherein the added elements are based on the supplemental data.

8. The method of claim 4, wherein the portion of the aggregated content listing is modified based on the identity associated with the control point device.

9. The method of claim 1, wherein selecting the subset of the content listings comprises selecting the subset based on a user identity associated with the control point device.

10. The method of claim 1, wherein selecting the subset of the content listings comprises selecting the subset based on a bandwidth capability associated with a rendering function of the control point device.

11. The method of claim 1, further comprising storing, with the content listing, a profile associated with the user identity, wherein the profile is used to select the subset of content listings.

12. The method of claim 1, wherein the ad-hoc peer-to-peer network comprises a Universal Plug and Play network.

13. An apparatus comprising:
a network interface capable of communicating via an ad-hoc peer-to-peer network;
a processor coupled to the network interface; and
a memory coupled to the processor, the memory including,
a content gathering module having instructions that cause the processor to,
gather, from a plurality of media servers coupled to the network, content listings that describe content available via the associated media server; and
a directory service module having instructions that cause the processor to,
accept, via the network interface, requests for content listings from one or more control point devices coupled to the network;
select a subset of the content listings based on an identity associated with the control point devices; and
present, to the control point devices via the network interface, an aggregated content listing based on the selected subset of the content listings.

14. The apparatus of claim 13, further comprising a transformation module having instructions that cause the processor to modify at least a portion of the aggregated content listing.

15. The apparatus of claim 14, wherein the transformation module modifies at least the portion of the aggregated content listing so that the aggregated content listing is in a consistent format.

16. The apparatus of claim 14, wherein the transformation module modifies at least the portion of the aggregated content listing based on the identity associated with the control point device.

17. The apparatus of claim 14, wherein the transformation module adds elements to the content listings.

18. The apparatus of claim 17, further comprising a data store configured to store supplemental data related to the aggregated content listing, and wherein the transformation module adds elements to the content listings based on the supplemental data.

19. The apparatus of claim 13, further comprising a preferences module having instructions that cause the processor to store a profile associated with the user identity, and wherein the directory service module uses the profile to select the subset of content listings.

20. The apparatus of claim 13, wherein the ad-hoc peer-to-peer network comprises a Universal Plug and Play network.

21. An apparatus comprising:
a network interface capable of communicating via an ad-hoc peer-to-peer network;
a processor coupled to the network interface; and
a memory coupled to the processor, the memory including instructions that cause the processor to,
select an identifier usable for accessing an aggregated content directory service;
request an aggregated content listing from aggregated content directory service using the identifier, the aggregated content listing containing entries gathered from a plurality of media servers accessible via the network interface; and
receive a subset of the aggregated content listing from the aggregated content directory service, the subset selected based on the identifier submitted to the aggregated content directory service.

22. The apparatus of claim 21, wherein the identifier references a profile of the apparatus, the profile usable by the aggregated content directory service to provide the subset of the aggregated content listing to the apparatus.

23. The apparatus of claim 21, wherein the network interface comprises a wireless network interface.

24. The apparatus of claim 21, wherein the ad-hoc peer-to-peer network comprises a Universal Plug and Play network.

25. A computer-readable medium having instructions stored thereon which are executable by a data processing arrangement capable of being coupled to a network for performing steps comprising:
gathering, from a plurality of media servers coupled to the network, content listings that describe content available via the associated media server;
accepting, via the network, requests for content listings from one or more control point devices coupled to the network;
selecting a subset of the content listings based on an identity associated with the control point devices; and
presenting, to the control point devices via the network, an aggregated content listing based on the selected subset of the content listings.

26. The computer-readable medium of claim 25, wherein the steps further comprise modifying at least a portion of the aggregated content listing so that the subset of content listings is in a consistent format.

27. The computer-readable medium of claim 26, wherein modifying at least a portion of the aggregated content comprises removing elements from the content listings.

28. The computer-readable medium of claim 26, wherein modifying at least a portion of the aggregated content comprises adding elements to the content listings.

29. The computer-readable medium of claim 28, wherein the steps further comprise storing supplemental data related to the content listings in a database separate from the content listings of the media servers, and wherein the added elements are based on the supplemental data.

30. The computer-readable medium of claim 25, wherein the ad-hoc peer-to-peer network comprises a Universal Plug and Play network.

31. A computer-readable medium having instructions stored thereon which are executable by a data processing arrangement capable of being coupled to a network for performing steps comprising:
selecting an identifier usable for accessing an aggregated content directory service;
requesting an aggregated content listing from aggregated content directory service using the identifier, the aggregated content listing containing entries gathered from a plurality of media servers; and
receiving a subset of the aggregated content listing, the subset selected based on the identifier submitted to the aggregated content directory service.

32. The computer-readable medium of claim 31, wherein the identifier references a profile of the data processing arrangement, the profile usable by the aggregated content directory service to provide the subset of the aggregated content listing to the data processing arrangement.

33. The computer-readable medium of claim 31, wherein the data processing arrangement is capable of being coupled to a network interface via a wireless network interface.

34. The computer-readable medium of claim 31, wherein the ad-hoc peer-to-peer network comprises a Universal Plug and Play network.

35. A system, comprising:
at least one control point device capable of being coupled to an ad-hoc peer-to-peer network;
a plurality of media servers capable of being coupled to the network;
means for gathering content listings from the plurality of media servers, each content listing describing content available via the associated media server;
means for selecting a subset of the content listings based on an identity associated with the control point device; and
means for presenting an aggregated content listing to the control point device, the aggregated content listing based on the selected subset of the content listings.

36. The system of claim 35, further comprising means for modifying at least a portion of the aggregated content listing so that the subset of content listings is in a consistent format.
